(19) United States
(12) Patent Application Publication
(10) Pub. No.: US 2005/0228967 A1
(43) Pub. Date: Oct. 13, 2005

(54) Methods and apparatus for reducing power dissipation in a multi-processor system

(75) Inventor: Koji Hirairi, Austin, TX (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Computer Entertainment Inc., Tokyo (JP)

(21) Appl. No.: 10/801,308

(22) Filed: Mar. 16, 2004

(51) Int. Cl. G06F 15/76

(52) U.S. Cl. 712/1

(57) ABSTRACT

Methods and apparatus for monitoring processor tasks and associated processor loads therefor that are allocated to be performed by respective sub-processing units associated with a main processing unit; re-allocating at least some of the tasks based on their associated processor loads such that at least one of the sub-processing units is not scheduled to perform any tasks; and commanding the sub-processing units that are not scheduled to perform any tasks into a low power consumption state.

### BACKGROUND OF THE INVENTION

The present invention relates to methods and apparatus for reducing power dissipation in a multi-processor system and, in particular, for allocating tasks among multiple processors in the system in order to reduce the overall power dissipated by the multi-processors.

Real-time, multimedia, applications are becoming increasingly important. These applications require extremely fast processing speeds, such as many thousands of megabits of data per second. While single processing units are capable of fast processing speeds, they cannot generally match the processing speeds of multi-processor architectures. Indeed, in multi-processor systems, a plurality of processors can operate in parallel (or at least in concert) to achieve desired processing results.

The types of computers and computing devices that may employ multi-processing techniques are extensive. In addition to personal computers (PCs) and servers, these computing devices include cellular telephones, mobile computers, personal digital assistants (PDAs), set top boxes, digital televisions and many others.

A design concern in a multi-processor system is how to manage the heat created by the plurality of processors, particularly when they are utilized in a small package, such as a hand-held device or the like. While mechanical heat management techniques may be employed, they are not entirely satisfactory because they add recurring material and labor costs to the final product. Mechanical heat management techniques also might not provide sufficient cooling.

Another concern in multi-processor systems is the efficient use of available battery power, particularly when multiple processors are used in portable devices, such as lap-top computers, hand held devices and the like. Indeed, the more processors that are employed in a given system, the more power will be drawn from the power source. Generally, the amount of power drawn by a given processor is a function of the number of instructions being executed by the processor and the clock frequency at which the processor operates.

Therefore, there is a need in the art for new methods and apparatus for achieving efficient multi-processing that reduces heat produced by the processors and the energy drawn thereby.

### SUMMARY OF THE INVENTION

A new computer architecture has also been developed in order to overcome at least some of the problems discussed above.

In accordance with this new computer architecture, all processors of a multi-processor computer system are constructed from a common computing module (or cell). This common computing module has a consistent structure and preferably employs the same instruction set architecture. The multi-processor computer system can be formed of one or more clients, servers, PCs, mobile computers, game machines, PDAs, set top boxes, appliances, digital televisions and other devices using computer processors.

A plurality of the computer systems may be members of a network if desired. The consistent modular structure enables efficient, high speed processing of applications and data by the multi-processor computer system, and if a network is employed, the rapid transmission of applications and data over the network. This structure also simplifies the building of members of the network of various sizes and processing power and the preparation of applications for processing by these members.

The basic processing module is a processor element (PE). A PE preferably comprises a processing unit (PU), a direct memory access controller (DMAC) and a plurality of sub-processing units (SPUs), such as four SPUs, coupled over a common internal address and data bus. The PU and the SPUs interact with a shared dynamic random access memory (DRAM), which may have a cross-bar architecture. The PU schedules and orchestrates the processing of data and applications by the SPUs. The SPUs perform this processing in a parallel and independent manner. The DMAC controls accesses by the PU and the SPUs to the data and applications stored in the shared DRAM.

In accordance with this modular structure, the number of PEs employed by a particular computer system is based upon the processing power required by that system. For example, a server may employ four PEs, a workstation may employ two PEs and a PDA may employ one PE. The number of SPUs of a PE assigned to processing a particular software cell depends upon the complexity and magnitude of the programs and data within the cell.

The plurality of PEs may be associated with a shared DRAM, and the DRAM may be segregated into a plurality of sections, each of these sections being segregated into a plurality of memory banks. Each section of the DRAM may be controlled by a bank controller, and each DMAC of a PE may access each bank controller. The DMAC of each PE may, in this configuration, access any portion of the shared DRAM.

The new computer architecture also employs a new programming model that provides for transmitting data and applications over a network and for processing data and applications among the network's members. This programming model employs a software cell transmitted over the network for processing by any of the network's members. Each software cell has the same structure and can contain both applications and data. As a result of the high speed processing and transmission speed provided by the modular computer architecture, these cells can be rapidly processed. The code for the applications preferably is based upon the same common instruction set and ISA. Each software cell preferably contains a global identification (global ID) and information describing the amount of computing resources required for the cell's processing. Since all computing resources have the same basic structure and employ the same ISA, the particular resource performing this processing can be located anywhere on the network and dynamically assigned.

In accordance with one or more aspects of the present invention, a method includes: monitoring processor tasks and associated processor loads therefor that are allocated to be performed by respective sub-processing units associated with a main processing unit; re-allocating at least some of the tasks based on their associated processor loads such that at least one of the sub-processing units is not scheduled to perform any tasks; and commanding the sub-processing units that are not scheduled to perform any tasks into a low power consumption state.

Each of the sub-processing units may include at least one of: (i) a power supply interrupt circuit; and (ii) a clock interrupt circuit; and may further include using at least one of the power supply interrupt circuit and the clock interrupt circuit to place the sub-processing units into the low power consumption state includes in response to the power-off command. Preferably, each of the sub-processing units includes a power supply and the power supply interrupt circuit; and the method includes using the power supply interrupt circuit to shut down the power supply in response to the power-off command to place the given sub-processing unit into the low power consumption state.

The main processing unit preferably includes a task load table containing the processor tasks and associated processor loads therefor that are allocated to be performed by the respective sub-processing units; and the method preferably further includes using the main processing unit to update the task load table in response to any changes in tasks and loads. The main processing unit preferably includes a task allocation unit operatively coupled to the task load table; and the method preferably further includes using the main processing unit to re-allocate at least some of the tasks based on their associated processor loads such that at least one of the sub-processing units is not scheduled to perform any tasks.

The method may include re-allocating all of the tasks of a given one of the sub-processing units to another one of the sub-processing units based on the associated processor loads such that the given one of the sub-processing units is not scheduled to perform any tasks. Alternatively or in addition, the method may include re-allocating some of the tasks of a given one of the sub-processing units to one or more of the other sub-processing units based on the associated processor loads such that the given one of the sub-processing units is not scheduled to perform any tasks.

In accordance with one or more further aspects of the present invention, an apparatus may include a plurality of sub-processing units, each operable to perform processor tasks; and a main processing unit operable to: (i) monitor the processor tasks and associated processor loads therefor that are allocated to be performed by the respective sub-processing units; (ii) re-allocate at least some of the tasks based on their associated processor loads such that at least one of the sub-processing units is not scheduled to perform any tasks; and (iii) issue a power-off command indicating that the sub-processing units that are not scheduled to perform any tasks should enter a low power consumption state.

In accordance with one or more further aspects of the present invention, a main processor may operate under the control of a software program to perform steps, comprising: monitoring processor tasks and associated processor loads therefor that are allocated to be performed by respective sub-processing units associated with the main processing unit; re-allocating at least some of the tasks based on their associated processor loads such that at least one of the sub-processing units is not scheduled to perform any tasks; and commanding the sub-processing units that are not scheduled to perform any tasks into a low power consumption state.

Other aspects, features, and advantages of the present invention will be apparent to one skilled in the art from the description herein taken in conjunction with the accompanying drawings.

### DESCRIPTION OF THE DRAWINGS

For the purposes of illustration, there are forms shown in the drawings that are presently preferred, it being understood, however, that the invention is not limited to the precise arrangements and instrumentalities shown.

FIG. 1 is a graphical illustration of static power, dynamic power, and total power curves versus processing load in a multi-processor system;

FIG. 2 is a graphical illustration of static power, dynamic power, and total power curves versus processing load in a multi-processor system employing variable voltage and clock frequency control techniques;

FIG. 3 is a block diagram of a multi-processing system in accordance with one or more aspects of the present invention;

FIG. 4 is a diagram illustrating an exemplary structure of a processor element (PE) in accordance with the present invention;

FIG. 5 is a diagram illustrating the structure of an exemplary sub-processing unit (SPU) in accordance with the present invention;

FIG. 6 is a diagram of a main processor unit (PU) in accordance with one or more aspects of the present invention;

FIG. 7 is a task load table of the main processor of FIG. 5 in accordance with one or more aspects of the present invention;

FIG. 8 is the task load table of FIG. 7 indicating a re-allocation of tasks to another sub-processing unit in accordance with one or more aspects of the present invention;

FIG. 9 is the task load table of FIG. 7 indicating a re-allocation of tasks to two other sub-processing units in accordance with one or more aspects of the present invention;

FIG. 10 is the task load table of FIG. 7 indicating a re-allocation of tasks such that at least one sub-processing unit has no scheduled tasks in accordance with one or more aspects of the present invention;

FIG. 11 is a graphical illustration of static power, dynamic power, and total power curves versus processing load in a multi-processor system using the main processor unit of FIG. 6 and in accordance with one or more further aspects of the present invention;

FIG. 12 is a block diagram illustrating task migration flow directions in accordance with one or more aspects of the present invention; and

FIGS. 13A-C are graphical illustrations of further task migration flow directions in accordance with various aspects of the present invention.

### DETAILED DESCRIPTION OF THE PREFERRED EMBODIMENTS

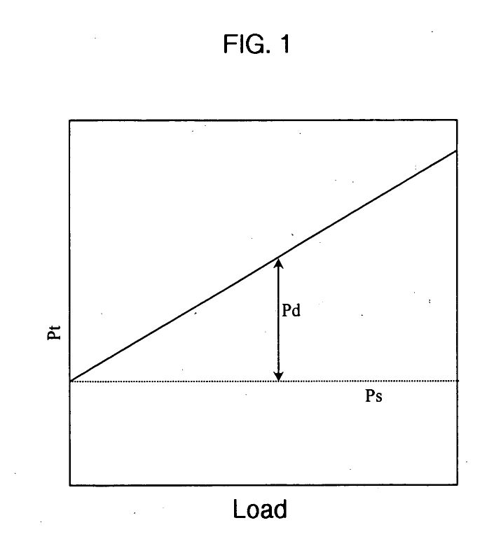

In order to place the various aspects of the present invention into context, reference is made to the graphical illustration of static power, dynamic power, and total power curves shown in FIG. 1. These power curves are examples of the power characteristics produced by a processing unit as a function of the processing load of such processor.

The static power Ps is equal to the leakage current, I1, multiplied by the operating voltage, Vdd, of the processing unit, which may be expressed as follows: Ps=I1×Vdd. When the leakage current I1 and the operating voltage Vdd are constant, then the static power Ps is also constant as a function of the processing load of the processor, as is illustrated in FIG. 1. The dynamic power Pd dissipated by the processor may be expressed as follows: Pd=Sf×C×F×Vdd², where Sf is the processing load of the processor, C is the equivalent capacitance of the processor, F is the clock frequency, and Vdd is the operating voltage. Sf is indicative of the number of transistors of the processing unit that need to be turned on and off in order to perform a particular task or group of tasks. The equivalent capacitance C is indicative of the aggregate capacitance of the transistors involved in connection with the task or tasks. Analysis of the equation for Pd indicates that the dynamic power Pd rises as a linear function of the processing load Sf, as is shown in FIG. 1.

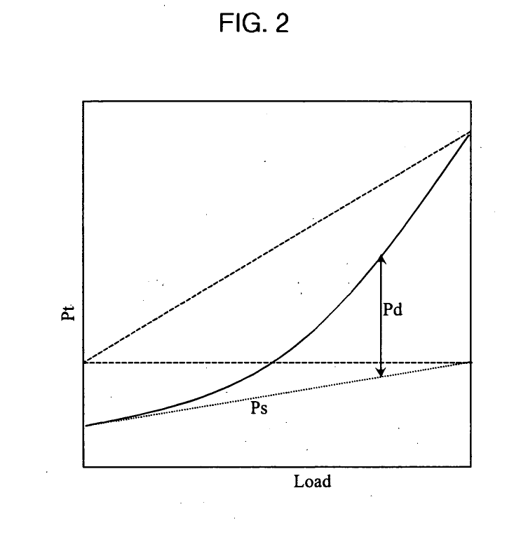

The total power Pt produced by the processor at any given point in time is equal to the sum of the static and dynamic power: Pt=Ps+Pd. The total power Pt may be reduced when the well-known voltage/frequency control (VFC) technique is employed. With reference to FIG. 2, when the VFC technique is employed, at least one of the operating voltage Vdd and the clock frequency F is varied as a function of the performance required from the processor. For example, if only a relatively low level of performance is required from the processor at any given period of time, then one or both of the operating voltage Vdd and the clock frequency F may be reduced. With reference to the equations for Ps and Pd, if the operating voltage Vdd is reduced, then the static power Ps and the dynamic power Pd will also be reduced. If only the clock frequency F is reduced, then only the dynamic power Pd is reduced.

As shown in FIG. 2, the static power resulting from VFC techniques (labeled Ps (VFD)) is generally lower than the static power Ps when VFC techniques are not employed. More particularly, the static power Ps (VFD) ramps up linearly from a significantly low level up to a higher level as a function of the processing load Sf. Similarly, the dynamic power resulting from the VFC technique (labeled Pd (VFC)) is generally lower than the dynamic power Pd without VFC. More particularly, the dynamic power Pd (VFC) starts from a relatively lower level and exhibits a quadratic characteristic as a function of the processing load Sf. This is so because the dynamic power Pd (VFC) is a function of the square of the operating voltage Vdd.

As can be gleaned from the curves of FIG. 2, the total power resulting from VFC techniques may be substantially lower than the total power when VFC is not employed. Unfortunately, irrespective of whether VFC is employed, the problem of managing power dissipation in processors persists. Indeed, Moore's law dictates that the scale of processors increases by a factor of two every 18 months. As the scale of processors increases, so too does the static power Ps. In the near future, the static power Ps may be even more significant than the dynamic power Pd. Thus, techniques are being considered for controlling the static power Ps even further.

One approach to reducing the static power Ps involves employing a transistor threshold voltage (Vth) technique. Recall that the static power Ps=I1×Vdd, where I1 is the leakage current and Vdd is the operating voltage of the processor. The leakage current I1 is a function of the scale of the processing unit, which is ever increasing. The scale of the processor is proportional to 1/e^{Vth}, where Vth is the threshold voltage of the transistors utilized to implement the processor. Thus, it may be desirable to increase the threshold voltage Vth of the transistors utilized to implement the processor in order to reduce the leakage current I1, thereby reducing the static power Ps.

Unfortunately, there are two significant problems with this approach, namely, it adversely affects the clock frequency, and it is not readily employed in certain processor fabrication scenarios. As to the former, the clock frequency F is a function of (Vdd−Vth)². Thus, as one increases the threshold voltage Vth, the theoretical clock frequency F of the processor must reduce. Although one might want to reduce the clock frequency F to employ VFC techniques, one does not want to be limited in the maximum clock frequency F achievable.

As to the latter problem, while controlling the threshold voltage Vth may have application in BULK CMOS processes, it is very difficult of employ in other processes, such as silicon-on-insulator (SOI) processes. Indeed, practical voltage threshold Vth control may be achieved in a bulk CMOS cirucit by varying the voltage relationship between the body (or bulk) terminals and the source terminals of the field effect transistors (FETs) of the circuit. This is relatively easily accomplished in a processor that has been fabricated utilizing the BULK CMOS process because that process dictates the use of a body terminal in the fabrication of the FET transistors of the processor. Thus, the voltage relationship between the body terminal and the source terminal of each transistor may be readily controlled. In contrast, the SOI process does not dictate the use of bulk/body terminals. Thus, to employ threshold voltage Vth control techniques in the SOI context would require changing the process to employ body/bulk terminals, which would adversely affect the spacing between the FET transistors of the circuit and the complexity of the implementation.

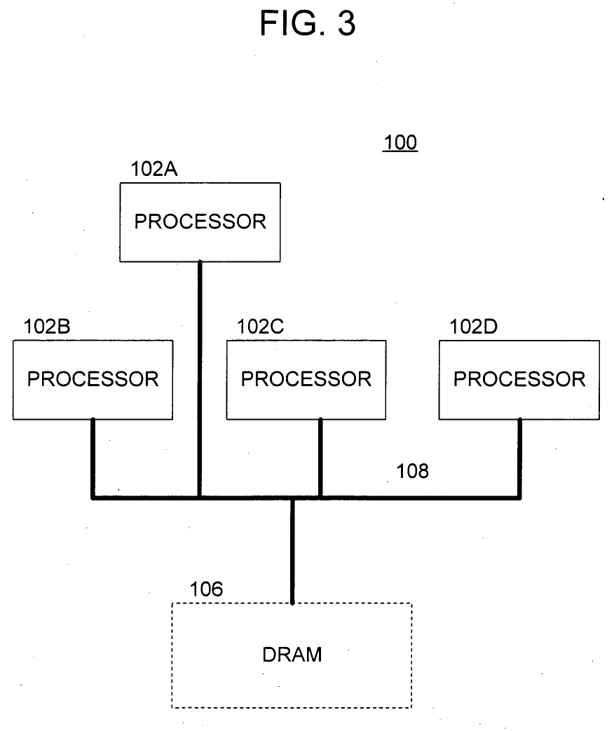

It has been discovered, however, that advantageous power management techniques may be achieved utilizing a multi-processing system in accordance with the present invention. In this regard, reference is made to FIG. 3, which illustrates a multi-processing system 100 in accordance with one or more aspects of the present invention. The multi-processing system 100 includes a plurality of processors 102 (any number may be used) coupled to a shared memory 106, such as a DRAM, over a bus 108. It is noted that the shared DRAM memory 106 is not required (and thus is shown in dashed line). Indeed, one or more of the processing units 102 may employ its own memory (not shown) and have no need for the shared memory 106.

One of the processors 102 is preferably a main processing unit, for example, processing unit 102A. The other processing units 102 are preferably sub-processing units (SPUs), such as processing unit 102B, 102C, 102D, etc. The processing units 102 may be implemented using any of the known computer architectures. All of the processing units 102 need not be implemented using the same architecture; indeed, they may be of heterogeneous or homogenous configurations. In operation, the main processing unit 102A preferably schedules and orchestrates the processing of data and applications by the sub-processing units 102B-D such that the sub-processing units 102B-D perform the processing of these data and applications in a parallel and independent manner.

It is noted that the main processing unit 102A may be disposed locally with respect to the sub-processing units 102B-D, such as in the same chip, in the same package, on the same circuit board, in the same product, etc. Alternatively, the main processing unit 102A may be remotely located from the sub-processing units 102B-D, such as in different products, which may be coupled over a bus, a communications network (such as the Internet) or the like. Similarly, the sub-processing units 102B-D may be locally or remotely located from one another.

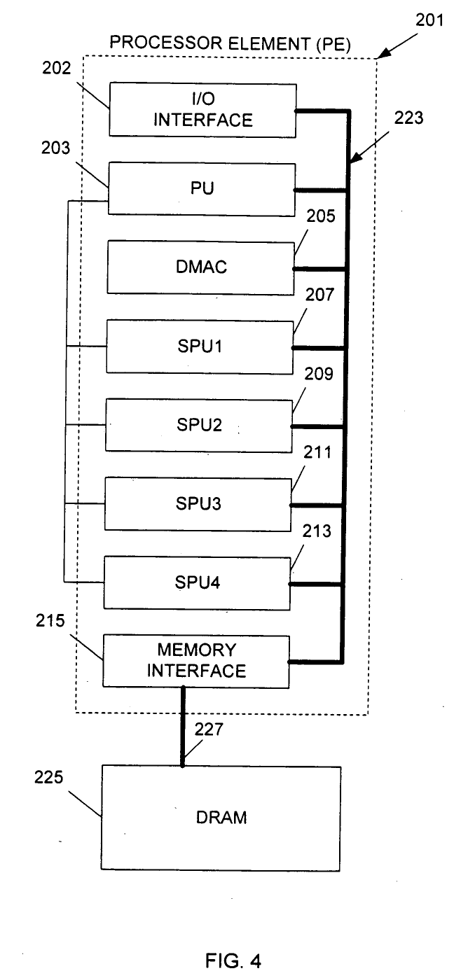

Reference is now made to FIG. 4, which is block diagram of a preferred multi-processing system employing a basic processing module or processor element (PE) 201. As shown in this figure, PE 201 comprises an I/O interface 202, a processing unit (PU) 203, a direct memory access controller (DMAC) 205, and a plurality of SPUs, namely, SPU 207, SPU 209, SPU 211, and SPU 213. A local (or internal) PE bus 223 transmits data and applications among PU 203, the SPUs, DMAC 205, and a memory interface 215. Local PE bus 223 can have, e.g., a conventional architecture or can be implemented as a packet switch network. Implementation as a packet switch network, while requiring more hardware, increases available bandwidth.

PE 201 can be constructed using various methods for implementing digital logic. PE 201 preferably is constructed, however, as a single integrated circuit employing a complementary metal oxide semiconductor (CMOS) on a silicon substrate. Alternative materials for substrates include gallium arsinide, gallium aluminum arsinide and other so-called III-B compounds employing a wide variety of dopants. PE 201 also could be implemented using superconducting material, e.g., rapid single-flux-quantum (RSFQ) logic.

PE 201 is closely associated with a dynamic random access memory (DRAM) 225 through a high bandwidth memory connection 227. DRAM 225 functions as the main (or shared) memory for PE 201. Although a DRAM 225 preferably is a dynamic random access memory, DRAM 225 could be implemented using other means, e.g., as a static random access memory (SRAM), a magnetic random access memory (MRAM), an optical memory or a holographic memory. DMAC 205 and memory interface 215 facilitate the transfer of data between DRAM 225 and the SPUs and PU 203 of PE 201. It is noted that the DMAC 205 and/or the memory interface 215 may be integrally or separately disposed with respect to the sub-processing units and the PU 203. Indeed, instead of a separate configuration as shown, the DMAC 205 function and/or the memory interface 215 function may be integral with one or more (preferably all) of the sub-processing units and the PU 203.

PU 203 can be, e.g., a standard processor capable of stand-alone processing of data and applications. In operation, PU 203 schedules and orchestrates the processing of data and applications by the SPUs. The SPUs preferably are single instruction, multiple data (SIMD) processors. Under the control of PU 203, the SPUs perform the processing of these data and applications in a parallel and independent manner. DMAC 205 controls accesses by PU 203 and the SPUs to the data and applications stored in the shared DRAM 225. It is noted that the PU 203 may be implemented by one or more of the sub-processing units taking on the role of a main processing unit.

A number of PEs, such as PE 201, may be joined or packaged together to provide enhanced processing power.

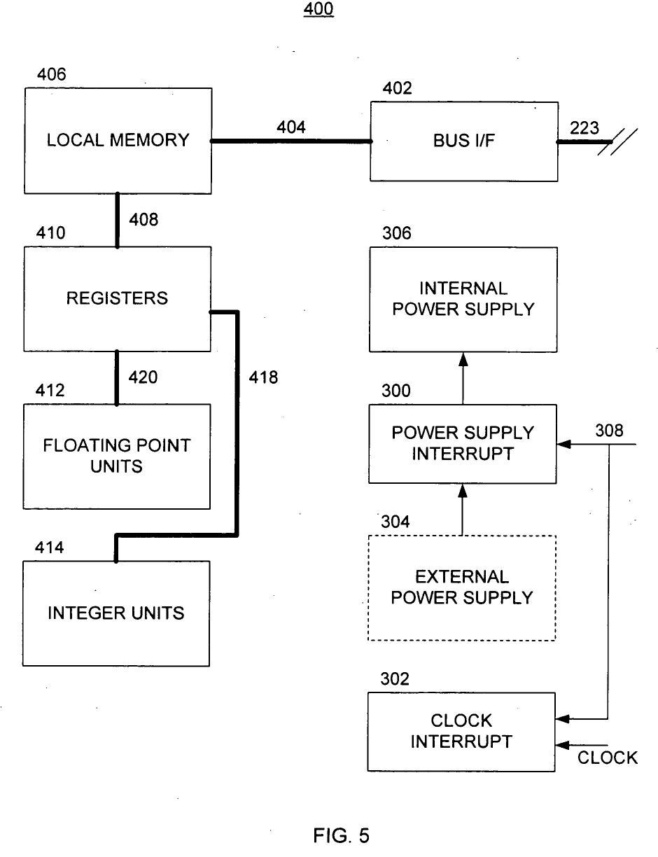

FIG. 5 illustrates the structure and function of an SPU 400. SPU 400 includes local memory 406, registers 410, one ore more floating point units 412 and one or more integer units 414. Again, however, depending upon the processing power required, a greater or lesser number of floating points units 412 and integer units 414 may be employed. In a preferred embodiment, local memory 406 contains 128 kilobytes of storage, and the capacity of registers 410 is 128×128 bits. Floating point units 412 preferably operate at a speed of 32 billion floating point operations per second (32 GFLOPS), and integer units 414 preferably operate at a speed of 32 billion operations per second (32 GOPS).

In a preferred embodiment, the local memory 406 contains 256 kilobytes of storage, and the capacity of registers 410 is 128×128 bits. It is noted that processor tasks are not executed using the shared memory 225. Rather, the tasks are copied into the local memory 406 of a given sub-processing unit and executed locally.

Local memory 406 may or may not be a cache memory. Cache coherency support for an SPU is preferably unnecessary. Instead, local memory 406 is preferably constructed as a static random access memory (SRAM). A PU 203 may require cache coherency support for direct memory accesses initiated by the PU 203. Cache coherency support is not required, however, for direct memory accesses initiated by the SPU 400 or for accesses from and to external devices.

SPU 400 further includes bus 404 for transmitting applications and data to and from the SPU 400. The sub-processing unit 400 further includes a bus interface (I/F) 402 for transmitting applications and data to and from the sub-processing unit 400. In a preferred embodiment, the bus I/F 402 is coupled to DMAC (not shown) that is integrally disposed within the sub-processing unit 400. Note that the DMAC may be externally disposed (as shown in FIG. 5). A pair of busses interconnect the integrally disposed DMAC between the bus I/F 402 and the local memory 406. The busses would preferably be 256 bits wide. In a preferred embodiment, bus 404 is 1,024 bits wide.

SPU 400 further includes internal busses 408, 420 and 418. In a preferred embodiment, bus 408 has a width of 256 bits and provides communications between local memory 406 and registers 410. Busses 420 and 418 provide communications between, respectively, registers 410 and floating point units 412, and registers 410 and integer units 414. In a preferred embodiment, the width of busses 418 and 420 from registers 410 to the floating point or integer units is 384 bits, and the width of busses 418 and 420 from the floating point or integer units 412, 414 to registers 410 is 128 bits. The larger width of these busses from registers 410 to the floating point or integer units 412, 414 than from these units to registers 410 accommodates the larger data flow from registers 410 during processing. A maximum of three words are needed for each calculation. The result of each calculation, however, normally is only one word.

The SPU 400 (and/or any of the SPUs 102 of FIG. 3) also preferably includes at least one of a power supply interrupt circuit 300 and a clock interrupt circuit 302. When the power supply interrupt circuit 300 is employed, the power supply to the SPU 400 may be external 304 or internal 306. It is most preferred that the power supply be internally disposed. The power supply interrupt circuit 300 is preferably operable to place the APU 400 into a low power consumption state in response to a command signal on line 308. In particular, when commanded, the power supply interrupt circuit 300 preferably shuts down or otherwise interrupts the delivery of power from the internal power supply 306 to the circuitry of the SPU 400, thereby shutting down the SPU 400 and drawing very little or no power. Alternatively, if an external power supply 304 is employed, then the power supply interrupt circuit 300 preferably interrupts the delivery of power from such power supply to the SPU 400 in response to a command on line 308.

Similarly, if the clock interrupt circuit 302 is employed, it is preferably operable to place the SPU 400 into the low power consumption state by interrupting the system clock for the SPU 400, whether the system clock is generated internally or externally. The details as to placing the SPU 400 into the low power consumption state will be provided later in this description.

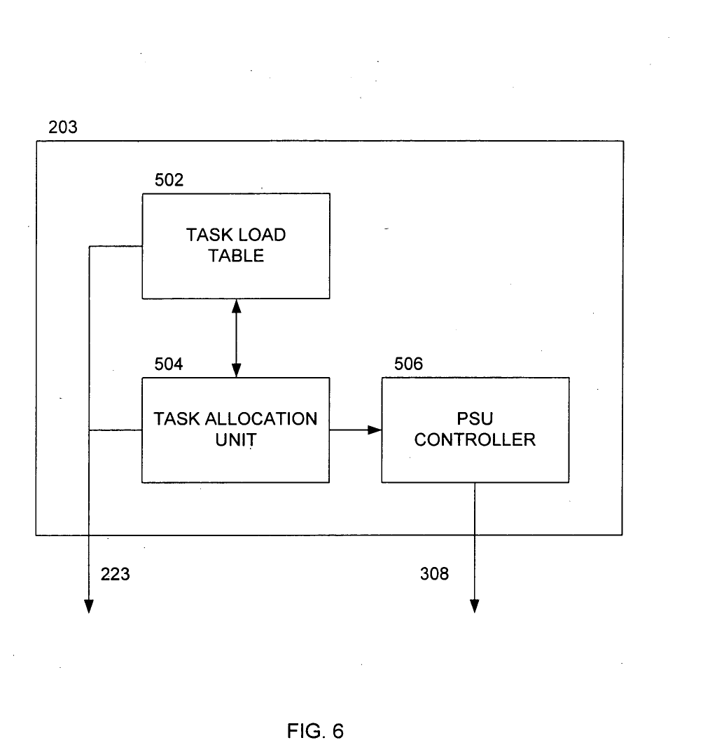

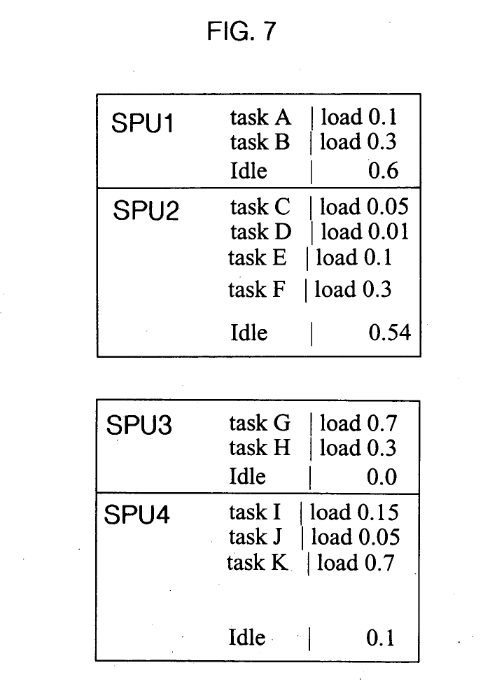

Reference is now made to FIG. 6, which is a block diagram of certain portions of a PU 203 in accordance with one or more aspects of the present invention. In particular, the PU 203 includes a task load table 502, a task allocation unit 504, and a PSU (or clock) controller 506. With reference to FIG. 7, the task load table 502 preferably contains processor tasks and associated processor loads that are allocated to be performed by the respective SPUs of the PE 201. As will be apparent to one skilled in the art, the task load table 502 may be implemented in hardware, firmware, or software, it being preferred that the task load table 502 is implemented utilizing appropriate software being executed on the PU 500. Turning again to FIG. 6, the task allocation unit 504 is operatively coupled to the task load table 502 and is operable to re-allocate at least some of the tasks based on their associated processor loads, such that at least one of the SPUs is not scheduled to perform any tasks.

For example, FIG. 7 shows that SPU1 is scheduled to perform task A and task B, where task A has an associated processor load of 0.1 and task B has an associated processor load of 0.3. Thus, SPU1 is idle for 0.6. SPU2 is scheduled to perform task C, task D, task E, and task F, with respective associated loads of 0.05, 0.01, 0.1, and 0.3. Thus, SPU2 is idle for 0.54. SPU3 is scheduled to perform task G and task H, with respective associated processor loads of 0.7 and 0.3. SPU3 is not idle. Finally, SPU4 is scheduled to perform task I, task J and task K, with respectively associated processor loads of 0.15, 0.05, 0.7. Thus, SPU4 is idle for 0.1.

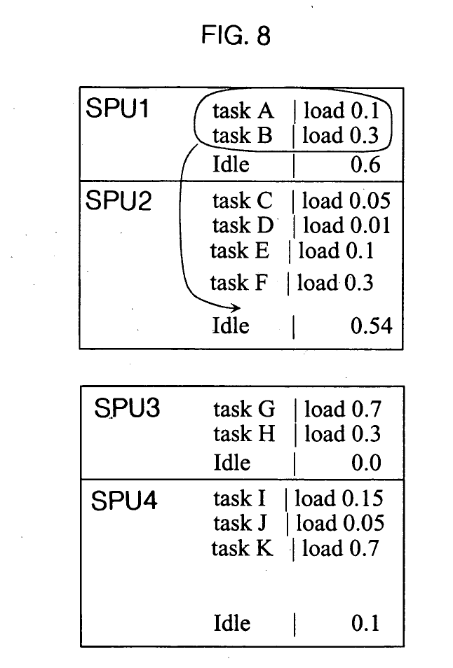

The task allocation unit 504 is preferably operable to utilize the information in the task load table 502 to re-allocate the tasks from at least one of the SPUs into one or more other SPUs. FIG. 8 illustrates one example of how the tasks from SPU1 may be re-allocated by the task allocation unit 504 to SPU2. In particular, the task allocation unit 504 may be operable to determine that the total load required to perform tasks A and B, i.e., 0.4, is less than the idle quantity associated with SPU2. Thus, the task allocation unit 504 may determine that both tasks A and B may be re-allocated from SPU1 to SPU2.

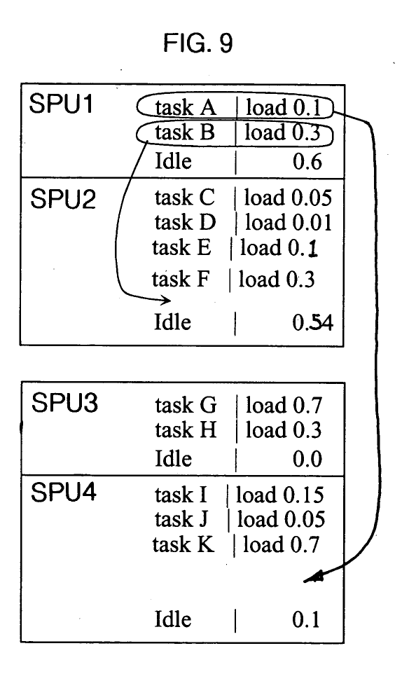

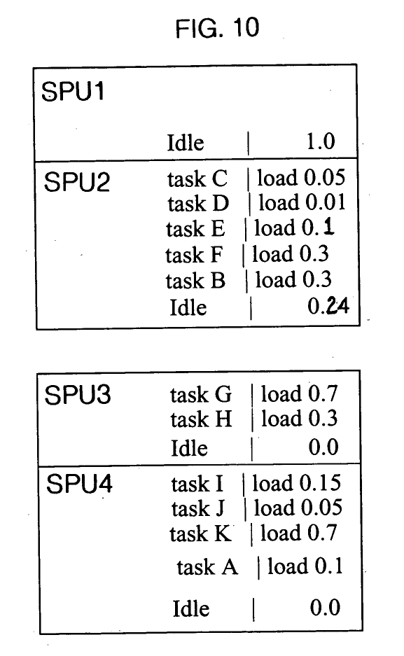

With reference to FIG. 9, the task allocation unit 504 may alternatively allocate the tasks from SPU1 to more than one other SPU, for example, SPU2 and SPU4. Again, the determination is preferably made based on the loads associated with each of the tasks being moved and the idle capabilities of the other participating SPUs. In keeping with the latter example, FIG. 10 illustrates the state of the task load table 502 after the task allocation unit 504 has re-allocated the tasks from SPU1. In particular, SPU1 is left with an idle characteristic of 1.0; SPU2 is left with an idle characteristic of 0.24; SPU3 is left with an idle characteristic of 0.0; and SPU4 is left with an idle characteristic of 0.0.

In response to an indication from the task allocation unit 504, the PSU controller 506 preferably issues a command over line 308 indicating that SPU1 should enter the low power consumption state. As was discussed above with respect to FIG. 5, this command causes at least one of the power supply interrupt circuit 300 and the clock interrupt circuit 302 to place the SPU1 into the low power consumption state. If additional processing tasks need to be performed that have associated processor loads in excess of the idle capabilities of the remaining SPUs, then the PSU controller 504 is preferably operable to provide an indication to SPU1 to leave the low power consumption state, thereby providing further processing capabilities for such tasks.

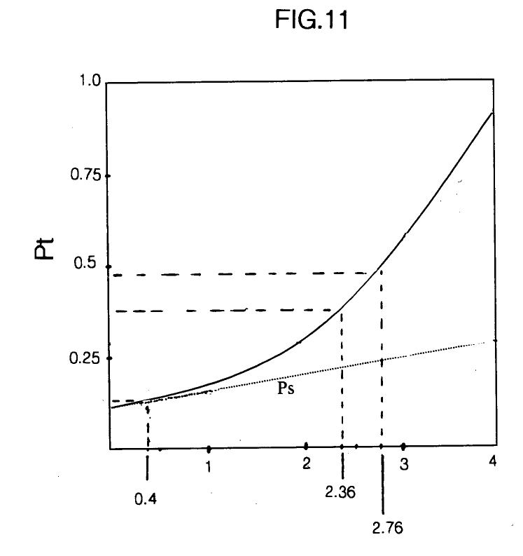

With reference to FIG. 11, the total power Pt produced by the all of the SPUs may be advantageously minimized through proper allocation of the tasks to be performed. Indeed, with the allocation of FIG. 7, the total power of the processing element Pt is the sum of the power dissipated by SPU1, SPU2, SPU3, and SPU4. On the other hand, with the allocation of FIG. 10, the total power dissipated by the processor element is the sum of the power dissipated by SPU2, SPU3, and SPU4. Although the processing loads of SPU2 and SPU4 are increased in the allocation of FIG. 10 as compared with the allocation of FIG. 7, the total power dissipation is lower. This is so because the static power Ps of SPU1 is avoided entirely. Turning again to FIG. 11, with the allocation of FIG. 7, SPU has a processing load of 0.4, which results in a power dissipation of 0.125 units; and the total processing load of SPU2, SPU3, and SPU4 is 2.36, with an associated power dissipation of 0.375. Thus, the total power Pt of the task allocation of FIG. 7, is 0.5 units. On the other hand, the task allocation of FIG. 10 results in a zero processing load for SPU1 and total processing load of 2.76 for SPU2, SPU3, and SPU4. This results in a total power Pt of 0.384, a 23.2% improvement.

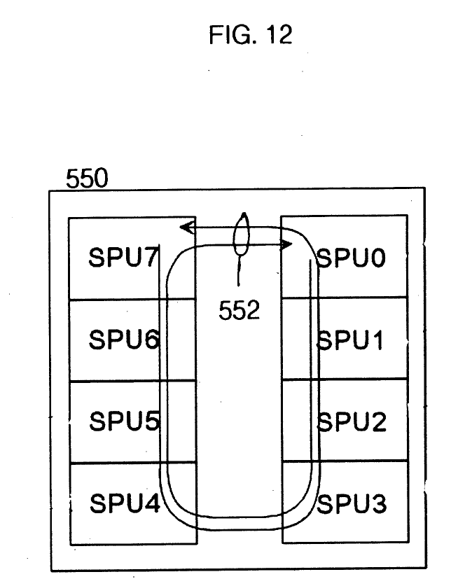

Reference is now made to FIG. 12, which is a block diagram illustrating one or more further aspects of the present invention. In this embodiment of the invention, a multi-processing system 550 includes a plurality of sub-processing units SPU0-7 that are sequentially interconnected by way of an internal bus 552. Processor task transfers from one SPU to another SPU may pass sequentially through one or more intermediately coupled SPUs unless the transfer is between adjacent SPUs. For example, a processor task migrating from SPU0 to SPU1 may simply be transferred sequentially from SPU0 to SPU1 over the internal bus 552. On the other hand, a processor task migration from SPU0 to SPU3 may pass through SPU1 and SPU2 or may pass through SPU7, SPU6, SPU5, and SPU4. This circular structure is preferable to a bumper-to-bumper arrangement where the SPUs are sequentially interconnected in a linear (not circular) arrangement. Indeed, with a linear arrangement there may be an excess latency in transferring processor tasks between SPUs that are disposed at extreme ends of the bus. With the circular arrangement of FIG. 12, however, latencies are reduced because processor tasks may be transferred in either of two directions through the bus 552.

It is noted that the multi-processing system 550 does not include a main processing unit or PU to manage the allocation and/or migration of tasks among the SPUs. Instead, a task table (which may be substantially similar to that described hereinabove with respect to FIGS. 6-10) may be shared among the SPUs and/or may be distributed among the SPUs. In any case, the SPUs may utilize the task table 502 to migrate the processor tasks among the SPUs to achieve the power management advantages described in detail in the other embodiments of this description.

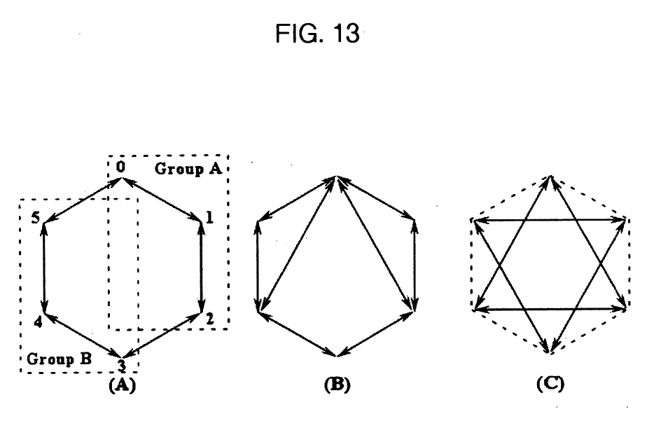

It is noted that even with the circular arrangement of FIG. 12, latency and other processing issues may arise in connection with transferring processor tasks between extreme ends of the structure, such as between SPU0 and SPU4. Thus, it is desirable to segregate the SPUs into two or more groups. For example, as illustrated in FIG. 13A, SPU0, SPU1, and SPU2 may be organized into group A, while SPU3, SPU4, and SPU5 may be organized into group B. With this arrangement, processor tasks would only be transferred among the SPUs in a given group, thereby reducing latency problems and/or other barriers to efficient multi-tasking. Further, any sharing and/or distribution of a task table may be limited to the SPUs of a given group, thereby further improving the efficiency of task processing and migration. FIGS. 13B and 13C illustrate alternative groupings and permissible task transfers between SPUs. Those skilled in the art will appreciate that many other modifications (including numbers of SPUs in the system) may be made without departing from the spirit and scope of the invention.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method, comprising:
monitoring processor tasks and associated processor loads therefor that are allocated to be performed by respective sub-processing units associated with a main processing unit;
re-allocating at least some of the tasks based on their associated processor loads such that at least one of the sub-processing units is not scheduled to perform any tasks; and
commanding the sub-processing units that are not scheduled to perform any tasks into a low power consumption state.

2. The method of claim 1, wherein:
each of the sub-processing units include at least one of: (i) a power supply interrupt circuit; and (ii) a clock interrupt circuit; and
the method includes using at least one of the power supply interrupt circuit and the clock interrupt circuit to place the sub-processing units into the low power consumption state includes in response to the power-off command.

3. The method of claim 2, wherein each of the sub-processing units includes a power supply and the power supply interrupt circuit; and
the method includes using the power supply interrupt circuit to shut down the power supply in response to the power-off command to place the given sub-processing unit into the low power consumption state.

4. The method of claim 1, wherein:
the main processing unit includes a task load table containing the processor tasks and associated processor loads therefor that are allocated to be performed by the respective sub-processing units; and
the method includes using the main processing unit to update the task load table in response to any changes in tasks and loads.

5. The method of claim 4, wherein:
the main processing unit includes a task allocation unit operatively coupled to the task load table; and
the method includes using the main processing unit to re-allocate at least some of the tasks based on their associated processor loads such that at least one of the sub-processing units is not scheduled to perform any tasks.

6. The method of claim 5, further comprising re-allocating all of the tasks of a given one of the sub-processing units to another one of the sub-processing units based on the associated processor loads such that the given one of the sub-processing units is not scheduled to perform any tasks.

7. The method of claim 5, further comprising re-allocating some of the tasks of a given one of the sub-processing units to one or more of the other sub-processing units based on the associated processor loads such that the given one of the sub-processing units is not scheduled to perform any tasks.

8. The method of claim 1, further comprising reducing the dynamic power dissipation of at least one of the sub-processing units using at least one of the main processing unit and one or more of the sub-processing units to carry out variable clock frequency control.

9. The method of claim 1, further comprising reducing the static and dynamic power dissipation of at least one of the sub-processing units using at least one of the main processing unit and one or more of the sub-processing units to carry out variable power supply (Vdd) control.

10. An apparatus, comprising:
a plurality of sub-processing units, each operable to perform processor tasks; and
a main processing unit operable to: (i) monitor the processor tasks and associated processor loads therefor that are allocated to be performed by the respective sub-processing units; (ii) re-allocate at least some of the tasks based on their associated processor loads such that at least one of the sub-processing units is not scheduled to perform any tasks; and (iii) issue a power-off command indicating that the sub-processing units that are not scheduled to perform any tasks should enter a low power consumption state.

11. The apparatus of claim 10, wherein the sub-processing units include at least one of: (i) a power supply interrupt circuit; and (ii) a clock interrupt circuit, each of which are operable to place the given sub-processing unit into the low power consumption state in response to the power-off command.

12. The apparatus of claim 11, wherein each of the sub-processing units includes a power supply and the power supply interrupt circuit, and the power supply interrupt circuit is operable to shut down the power supply in response to the power-off command to place the given sub-processing unit into the low power consumption state.

13. The apparatus of claim 10, wherein:
the main processing unit includes a task load table containing the processor tasks and associated processor loads therefor that are allocated to be performed by the respective sub-processing units; and
the main processing unit is operable to update the task load table in response to any changes in tasks and loads.

14. The apparatus of claim 13, wherein: the main processing unit includes a task allocation unit operatively coupled to the task load table and operable to re-allocate at least some of the tasks based on their associated processor loads such that at least one of the sub-processing units is not scheduled to perform any tasks.

15. The apparatus of claim 14, wherein the task allocation unit is operable to re-allocate all of the tasks of a given one of the sub-processing units to another one of the sub-processing units based on the associated processor loads such that the given one of the sub-processing units is not scheduled to perform any tasks.

16. The apparatus of claim 15, wherein the main processing unit includes a power supply controller operatively coupled to the task allocation unit and operable to issue the power-off command signal to the given one of the sub-processing units in response to an indication from the task allocation unit that the given one of the sub-processing units is not scheduled to perform any tasks.

17. The apparatus of claim 14, wherein the task allocation unit is operable to re-allocate some of the tasks of a given one of the sub-processing units to one or more of the other sub-processing units based on the associated processor loads such that the given one of the sub-processing units is not scheduled to perform any tasks.

18. The apparatus of claim 15, wherein the main processing unit includes a power supply controller operatively coupled to the task allocation unit and operable to issue the power-off command signal to the given one of the sub-processing units in response to an indication from the task allocation unit that the given one of the sub-processing units is not scheduled to perform any tasks.

19. The apparatus of claim 10, wherein at least one of the main processing unit and one or more of the sub-processing units are operable to carry out variable clock frequency control in order to reduce the dynamic power dissipation of at least one of the sub-processing units.

20. The apparatus of claim 10, wherein at least one of the main processing unit and one or more of the sub-processing units are operable to carry out variable power supply (Vdd) control in order to reduce the static and dynamic power dissipation of at least one of the sub-processing units.

21. The apparatus of claim 10, wherein at least one of the main processing unit and one or more of the sub-processing units are formed using a silicon-on-insulator fabrication process.

22. The apparatus of claim 10, wherein the main processing unit is at least one of remotely located from or locally located with one or more of the sub-processing units.

23. The apparatus of claim 10, wherein one or more of the sub-processing units are remotely located from one another.

24. The apparatus of claim 10, wherein the sub-processing units employ substantially heterogeneous computer architectures or a homogeneous computer architecture.

25. A main processor operating under the control of a software program to perform steps, comprising:
monitoring processor tasks and associated processor loads therefor that are allocated to be performed by respective sub-processing units associated with the main processing unit;
re-allocating at least some of the tasks based on their associated processor loads such that at least one of the sub-processing units is not scheduled to perform any tasks; and
commanding the sub-processing units that are not scheduled to perform any tasks into a low power consumption state.

26. The processor of claim 25, wherein:
each of the sub-processing units include at least one of: (i) a power supply interrupt circuit; and (ii) a clock interrupt circuit; and
at least one of the power supply interrupt circuit and the clock interrupt circuit respond to the power-off command by placing the sub-processing units into the low power consumption state.

27. The processor of claim 26, wherein each of the sub-processing units includes a power supply and the power supply interrupt circuit; and
the power supply interrupt circuit responds to the power-off command by shutting down the power supply to place the given sub-processing unit into the low power consumption state.

28. The processor of claim 25, wherein:
the main processing unit includes a task load table containing the processor tasks and associated processor loads therefor that are allocated to be performed by the respective sub-processing units; and
the steps include updating the task load table in response to any changes in tasks and loads.

29. The processor of claim 28, wherein:
the main processing unit includes a task allocation unit operatively coupled to the task load table; and
the steps include re-allocating at least some of the tasks based on their associated processor loads such that at least one of the sub-processing units is not scheduled to perform any tasks.

30. The processor of claim 29, further comprising re-allocating all of the tasks of a given one of the sub-processing units to another one of the sub-processing units based on the associated processor loads such that the given one of the sub-processing units is not scheduled to perform any tasks.

31. The processor of claim 29, further comprising re-allocating some of the tasks of a given one of the sub-processing units to one or more of the other sub-processing units based on the associated processor loads such that the given one of the sub-processing units is not scheduled to perform any tasks.

32. The processor of claim 25, further comprising reducing the dynamic power dissipation of at least one of the sub-processing units using at least one of the main processing unit and one or more of the sub-processing units to carry out variable clock frequency control.

33. The processor of claim 25, further comprising reducing the static and dynamic power dissipation of at least one of the sub-processing units using at least one of the main processing unit and one or more of the sub-processing units to carry out variable power supply (Vdd) control.

34. An apparatus, comprising:
a plurality of sub-processing units, each operable to perform processor tasks; and
a bus circularly interconnecting the sub-processing units such that transfers between any two sub-processing units may occur directly as between adjacent sub-processing units or through one or more intermediate sub-processing units as between more distant sub-processing units,
wherein the sub-processing units are operable to: (i) monitor the processor tasks and associated processor loads therefor that are allocated to be performed by the respective sub-processing units; (ii) re-allocate at least some of the tasks based on their associated processor loads.

35. The apparatus of claim 34 wherein the sub-processing units are arranged in groups and the re-allocation of one or more tasks of a sub-processing unit within a given one of the groups maintains such tasks within the given group.

36. The apparatus of claim 34 wherein the re-allocation of the tasks is performed such that at least one of the sub-processing units is not scheduled to perform any tasks.

37. The apparatus of claim 36, wherein the sub-processing units that are not scheduled to perform any tasks are operable to enter a low power consumption state.

38. The apparatus of claim 34, wherein:
the sub-processing units are operable to access a task load table containing the processor tasks and associated processor loads therefor that are allocated to be performed by the respective sub-processing units; and
the sub-processing units are operable to update the task load table in response to any changes in tasks and loads.

39. The apparatus of claim 38, wherein the sub-processing units are operable to re-allocate all of the tasks of a given one of the sub-processing units to another one of the sub-processing units based on the associated processor loads such that the given one of the sub-processing units is not scheduled to perform any tasks.
